(19) United States
(12) Patent Application Publication
(10) Pub. No.: US 2023/0376562 A1
(43) Pub. Date: Nov. 23, 2023

(54) INTEGRATED CIRCUIT APPARATUS FOR MATRIX MULTIPLICATION OPERATION, COMPUTING DEVICE, SYSTEM, AND METHOD

(71) Applicant: CAMBRICON TECHNOLOGIES CORPORATION LIMITED, Beijing (CN)

(72) Inventors: Zheng SUN, Beijing (CN); Ming LI, Beijing (CN); Yehao YU, Beijing (CN); Zhize CHEN, Beijing (CN); Yi BIAN, Beijing (CN)

(21) Appl. No.: 18/013,635

(22) PCT Filed: Dec. 29, 2021
(86) PCT No.: PCT/CN2021/142653

§ 371 Date: Aug. 7, 2023

(30) Foreign Application Priority Data
Dec. 30, 2020 (CN) 202011610669.4

(51) Int. Cl. G06F 17/16; G06F 7/544

(52) U.S. Cl. CPC G06F 17/16; G06F 7/5443

(57) ABSTRACT

An integrated circuit apparatus may be included in a computing processing apparatus of a combined processing apparatus. The computing processing apparatus includes one or a plurality of integrated circuit apparatuses. The combined processing apparatus may further include an interface apparatus and other processing apparatus. The computing processing apparatus interacts with other processing apparatus to jointly complete a computing operation specified by a user. The combined processing apparatus further includes a storage apparatus. The storage apparatus is connected to the apparatus and other processing apparatus, respectively. The storage apparatus is used to store data of the apparatus and other processing apparatus. The solution of the present disclosure may reduce the amount of data transferred between an internal device and an external storage apparatus, thus minimizing the I/O bottleneck caused by bandwidth limitations and then improving the overall performance of the integrated circuit apparatus.

### CROSS-REFERENCE TO RELATED APPLICATION AND CLAIM OF PRIORITY

This application claims benefit under 35 U.S.C. 119, 120, 121, or 365(c), and is a National Stage entry from International Application No. PCT/CN2021/142653, filed Dec. 29, 2021, which claims priority to the benefit of Chinese Patent Application No. 202011610669.4 filed in the Chinese Intellectual Property Office on Dec. 30, 2020, the entire contents of which are incorporated herein by reference.

### BACKGROUND

### 1. TECHNICAL FIELD

The present disclosure generally relates to the field of data processing. More specifically, the present disclosure relates to an integrated circuit apparatus for matrix multiplication, a board card, a computing device, a computing system, and a method.

### 2. BACKGROUND ART

A large number of data processing and operations are usually involved in the field of artificial intelligence, which include matrix multiplication of various types of data. Taking machine learning in the current field of artificial intelligence as an example, lots of computing tasks involve large-scale matrix multiplication, especially multiplication of large matrices. Further, taking deep learning in the machine learning as an example, the deep learning includes a large number of matrix multiplication of various types, including matrix multiplication of a weight matrix and an input vector in a fully connected layer and matrix multiplication of an input vector and a convolution kernel in a convolution layer. It may be conceived that the larger the data volume and scale involved in the matrix multiplication, the higher the requirement on storage volume of a computing platform (especially an on-chip system).

In existing matrix multiplication, a processor such as a central processing unit (CPU) or a graphics processing unit (GPU) is usually used. However, since the processor is limited by the resource capacity of an internal register, the large amount of data processing may lead to a lot of data interaction between the processor and an external memory. Since a bandwidth of an input/output (“I/O”) bus between the processor and the external memory is limited, a serious I/O bottleneck is likely to occur, causing delays in data transfer and greatly reducing the efficiency of parallel operations. Further, not only the bandwidth limitation of the I/O bus will become the bottleneck of system performance, but also the large amount of I/O access between the processor and the external memory will bring adverse effects on computing and power consumption.

### SUMMARY

To at least solve technical problems mentioned above, the present disclosure provides a solution where a hardware architecture and an operation method that may effectively execute matrix multiplication are provided, thus reducing the amount of data transmission with the external memory and minimizing the I/O bottleneck caused by the bus bandwidth limitation, which improves the operation efficiency of matrix multiplication. Specifically, the present disclosure provides the foregoing solution in several ways as follows.

A first aspect of the present disclosure discloses an integrated circuit apparatus for matrix multiplication, including: an interface unit, configured to acquire matrix data used for the matrix multiplication from an external memory, where the matrix data includes a first matrix and a second matrix, where the first matrix is divided to N² first matrix blocks, the second matrix is divided to N² second matrix blocks, and matrix multiplication of the first matrix and the second matrix includes N² matrix multiplication tasks based on the N² first matrix blocks and the N² second matrix blocks, where N is a positive integer greater than or equal to 2; and N² master computing units, where the N² master computing units are connected sequentially to form a data transfer loop, where each master computing unit is configured to execute one corresponding matrix multiplication task in the N² matrix multiplication tasks and includes: a plurality of storage areas, configured to store matrix blocks used for executing the matrix multiplication tasks and intermediate results; and a control unit, configured to execute matrix block exchange with an adjacent master computing unit.

In executing the one corresponding matrix multiplication task described above, each master computing unit is configured to: acquire one first matrix block and one second matrix block related to the matrix multiplication task through the interface unit, and store the one first matrix block in a first storage area and the one second matrix block in a second storage area; execute matrix multiplication on the one first matrix block and the one second matrix block to obtain one intermediate result; execute N−1 times of matrix block exchange with the adjacent master computing unit through the control unit and by using the first storage area and the second storage area, and execute matrix multiplication on a first matrix block and a second matrix block obtained after each exchange to obtain N−1 intermediate results respectively; and sum N intermediate results to complete the related matrix multiplication task.

A second aspect of the present disclosure discloses a board card, including the integrated circuit apparatus described above and later in a plurality of embodiments.

A third aspect of the present disclosure discloses a computing device, including the board card described above and later in a plurality of embodiments.

A fourth aspect of the present disclosure provides a computing system, including the computing device described above and later in a plurality of embodiments.

A fifth aspect of the present disclosure discloses a method for matrix multiplication using the integrated circuit apparatus described above and later in a plurality of embodiments, including: acquiring, by using an interface unit of the integrated circuit apparatus, matrix data used for the matrix multiplication from an external memory, where the matrix data includes a first matrix and a second matrix, where the first matrix is divided to N² first matrix blocks, the second matrix is divided to N² second matrix blocks, and matrix multiplication of the first matrix and the second matrix includes N² matrix multiplication tasks based on the N² first matrix blocks and the N² second matrix blocks, where N is a positive integer greater than or equal to 2; and executing, by using each master computing unit, following operations: acquiring one first matrix block and one second matrix block related to a matrix multiplication task through the interface unit, and storing the one first matrix block in a first storage area and the one second matrix block in a second storage area; executing matrix multiplication on the one first matrix block and the one second matrix block to obtain one intermediate result; executing N−1 times of matrix block exchange with an adjacent master computing unit through a control unit and by using the first storage area and the second storage area, and executing matrix multiplication on a first matrix block and a second matrix block obtained after each exchange to obtain N−1 intermediate results respectively; and summing N intermediate results to complete the related matrix multiplication task.

A sixth aspect of the present disclosure provides a computer program product that includes a program instruction used to execute matrix multiplication. When the program instruction is executed by one or more processors, the method described above and later in a plurality of embodiments is implemented.

By using the aforementioned integrated circuit apparatus, the computing device, the computing system, the board card, and the method of the present disclosure, on-chip resources of an on-chip system may be fully utilized, and data share and transfer are implemented among the master computing units, thus significantly reducing I/O data interaction with the external memory and then enabling efficient parallel execution of data transfer and multiplication. Further, by splitting the matrix to multi-level in combination with the hardware architecture, the solution of the present disclosure simplifies complexity of the matrix multiplication and supports matrix multiplication of super-large matrices. Besides, by significantly reducing the data interaction with the external memory, the solution of the present disclosure further improves execution efficiency of matrix multiplication and reduces operation performance bottlenecks caused by on-chip and off-chip I/O bandwidth limitations, thereby improving the overall performance of the integrated circuit apparatus, the computing device, the computing system, or the board card.

### BRIEF DESCRIPTION OF THE DRAWINGS

By reading the following detailed description with reference to drawings, the above and other objects, features and technical effects of exemplary embodiments of the present disclosure will become easier to understand. In the drawings, several embodiments of the present disclosure are shown in an exemplary but not a restrictive manner, and the same or corresponding reference numerals indicate the same or corresponding parts.

FIG. 1 is an exemplary architecture diagram of an integrated circuit apparatus according to an embodiment of the present disclosure.

FIG. 2 is a schematic structural diagram of a single master computing unit according to an embodiment of the present disclosure.

FIG. 3 is an architecture diagram of “2*2” master computing units according to an embodiment of the present disclosure.

FIG. 4A and FIG. 4B are block diagrams where “2*2” master computing units are used for convolution matrix multiplication according to embodiments of the present disclosure.

FIG. 5A and FIG. 5B are structural block diagrams where “2*2” computing sub-units are used for convolution matrix multiplication according to embodiments of the present disclosure.

FIG. 6 shows a pipeline operation performed by an integrated circuit apparatus according to an embodiment of the present disclosure.

FIG. 7 is a structural architecture diagram of “3*3” master computing units according to an embodiment of the present disclosure.

FIG. 8 shows a board card used for matrix multiplication according to an embodiment of the present disclosure.

FIG. 9 shows a computing system used for matrix multiplication according to an embodiment of the present disclosure.

FIG. 10 is a flowchart of a method used for performing matrix multiplication according to an embodiment of the present disclosure.

FIG. 11 is a structural diagram of a combined processing apparatus according to an embodiment of the present disclosure.

FIG. 12 is a schematic structural diagram of a board card according to an embodiment of the present disclosure.

### DETAILED DESCRIPTION OF THE EMBODIMENTS

The technical solution in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those skilled in the art based on the embodiments of the present disclosure without creative efforts shall fall within the scope of protection of the present disclosure.

Specific implementations of the present disclosure will be described in detail in combination with drawings below.

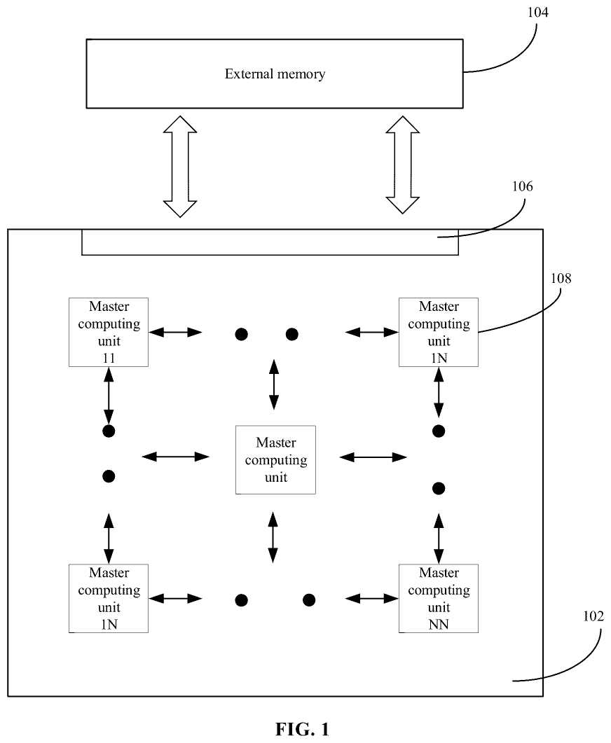

FIG. 1 is an exemplary architecture diagram of an integrated circuit apparatus 102 used for matrix multiplication according to an embodiment of the present disclosure. To facilitate understanding of the solution of the present disclosure, FIG. 1 further shows an external memory 104 interacting information with the integrated circuit apparatus 102. In an implementation scenario, the external memory may be a dynamic random access memory (DRAM), and matrix data related to the matrix multiplication of the present disclosure may be stored in the DRAM. Those skilled in the art may understand that the matrix multiplication may involve a first matrix and a second matrix, where the first matrix may be divided into N² first matrix blocks, the second matrix may be divided to N² second matrix blocks, where N is a positive integer greater than or equal to 2. For example, when N=2, the first matrix and the second matrix may be divided into 4 matrix blocks. For example, “4*4” first matrices or second matrices may be divided into 4 “2*2” first matrix blocks and second matrix blocks. For example, when N=3, the first matrix and the second matrix may be divided into 9 matrix blocks. For example, “6*6” first matrices or second matrices may be divided into 9 “2*2” first matrix blocks and second matrix blocks. Through the above block processing, the solution of the present disclosure may divide a large matrix multiplication operation into N² matrix multiplication tasks to be performed by a master computing unit of the present disclosure described in detail below.

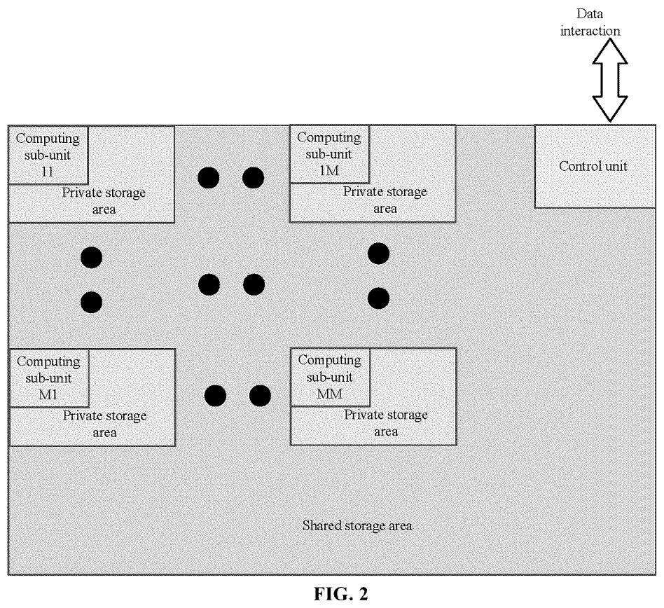

Further, as shown in FIG. 1, the integrated circuit apparatus 102 of the present disclosure may include an interface unit 106 and N² master computing units 108. In an application scenario, a direct memory access (DMA) interface may be used as the interface unit to send matrix data of the external memory to a plurality of master computing units 108, such as 5 master computing units exemplarily shown in the figure and one or a plurality of master computing units shown by black dots in the middle. It may be seen that the N² master computing units of the present disclosure may constitute an “N*N” computing array to perform the matrix multiplication in parallel. In an embodiment, the N² master computing units of the present disclosure are connected sequentially to form a data transfer loop, thereby transferring data including part of row blocks and column blocks in the first matrix block or the second matrix block to other master computing units in a continuous loop. The following will describe the master computing unit of the present disclosure in detail in combination with FIG. 2.

As shown in FIG. 2, the master computing unit of the present disclosure may include M² computing sub-units, which constitute an “M*M” computing array, where M is a positive integer greater than or equal to 2. According to different application scenarios, M may be equal to or not equal to N. For example, N=2 and M=2, or N=2 and M=3. Further, the master computing unit may include a plurality of storage areas, such as a shared storage area and a private storage area related to each computing sub-unit shown in the figure. In an embodiment, the shared storage area may be a storage area that is different from the private storage area. In another embodiment, the private storage area may be storage space in the shared storage area that is specifically allocated for temporary storage of the computing sub-units. In an implementation scenario, the plurality of storage areas in the master computing unit may be used to store matrix blocks used for executing the matrix multiplication tasks and intermediate results.

In order to realize data interaction with an adjacent master computing unit constituting the data transfer loop, the master computing unit of the present disclosure further includes a control unit, which is configured to execute matrix block exchange with the adjacent master computing unit. Therefore, by means of the interface unit between the integrated circuit apparatus and the external memory and the control unit of each master computing unit, the solution of the present disclosure enables the plurality of master computing units in the integrated circuit apparatus to acquire part of matrix block data of respective matrix multiplication tasks from the external memory and acquire another part (or more parts) of matrix block data from one or a plurality of master computing units that are connected adjacently through data interaction, thereby acquiring matrix block data required to complete corresponding matrix multiplication tasks and completing the corresponding matrix multiplication tasks based on this.

Specifically, in performing one corresponding matrix multiplication task, each master computing unit may be configured to acquire one first matrix block (which is from the first matrix) and one second matrix block (which is from the second matrix) related to the one corresponding matrix multiplication task through the interface unit and store the one first matrix block and the one second matrix block in a first storage area and a second storage area respectively. Besides, the first storage area and the second storage area may be two pieces of independent storage space allocated from the shared storage area and are used as buffer areas to store intermediate data.

After acquiring the one first matrix block and the one second matrix block, the master computing unit of the present disclosure may execute matrix multiplication on the one first matrix block and the one second matrix block to obtain one intermediate result. As mentioned before, here, the matrix multiplication of the one first matrix block and the one second matrix block may be executed in parallel pipelines by the M² computing sub-units in the master computing unit. Hereafter, the master computing unit may execute N−1 times of matrix block exchange with the adjacent master computing unit through the control unit and by using the first storage area and the second storage area and executes matrix multiplication on a first matrix block and a second matrix block obtained after each exchange to obtain N−1 intermediate results. For example, when N=2, which means that 4 master computing units are connected in serial, in one master computing unit, another first matrix block and second matrix block may be acquired from two master computing units that are connected adjacently, thereby obtaining an intermediate result again. After obtaining N intermediate results, the master computing unit of the present disclosure may sum these intermediate results to complete one related matrix multiplication task.

As mentioned before, the master computing unit of the present disclosure uses the M² computing sub-units to execute specific matrix multiplication tasks. Based on this arrangement, the matrix multiplication of the present disclosure may involve a case where the first matrix block and the second matrix block may be further divided. Specifically, the first matrix block and the second matrix block may be divided into M² first matrix sub-blocks and M² second matrix sub-blocks respectively. Based on this, one matrix multiplication task of the above one master computing unit may include M² matrix multiplication sub-tasks based on the M² first matrix sub-blocks and the M² second matrix sub-blocks. Further, each of the M² computing sub-units may be configured to execute one corresponding matrix multiplication sub-task in the M² matrix multiplication sub-tasks.

Specifically, in performing the one corresponding matrix multiplication sub-task, each computing sub-unit may be configured to execute M times of matrix multiplication to obtain M intermediate sub-results. Especially, the computing sub-unit may acquire one first matrix sub-block and one second matrix sub-block related to the matrix multiplication sub-task from the shared storage area (such as the first storage area and the second storage area) respectively. Next, the computing sub-unit may execute a matrix multiplication operation on one first matrix sub-block and one corresponding second matrix sub-block to obtain one intermediate sub-result. Finally, the computing sub-unit may sum the M intermediate sub-results to complete the related matrix multiplication sub-task.

Based on an internal architecture and matrix division of the integrated circuit apparatus of the present disclosure, the solution of the present disclosure also realize a high-level parallel operation. Especially, the N² master computing units may be configured to execute respective related matrix multiplication tasks in parallel, and the M² computing sub-units may be configured to execute respective related matrix multiplication sub-tasks in parallel. Besides, the matrix division of the present disclosure may be performed based on Cannon's algorithm rules. For example, the first matrix and the second matrix involved in the matrix multiplication of the present disclosure may be divided into the N² first matrix blocks and the N² second matrix blocks at the master computing unit level based on the Cannon's algorithm rules. Next, at the computing sub-unit level, the one first matrix block and the one second matrix block may be further divided based on the Cannon's algorithm rules to obtain the M² first matrix sub-blocks and the M² second matrix sub-blocks.

Through the descriptions in combination with FIG. 1 and FIG. 2, those skilled in the art may understand that the present disclosure performs multiple times (or rounds) of block processing on matrix multiplication among large (or super-large) matrices and performs the matrix multiplication through corresponding master computing units and computing sub-units, thereby realizing a parallel pipeline operation of the matrix multiplication. Thus, in terms of the matrix multiplication, the solution of the present disclosure realizes significant advantages of simplifying complexity of the matrix multiplication and accelerating the matrix multiplication. Further, the solution of the present disclosure acquires all matrix data from the external memory and performs matrix data exchange through the control unit in the master computing unit, thereby avoiding frequent data interaction with the external memory and breaking the bottleneck of existing I/O interaction. Further, the numbers of the master computing units and the computing sub-units may be flexibly set according to computing scenarios, and the matrix multiplication of any size may be realized in a cascading manner, thereby creating matrix multiplication operation scenarios that are flexibly set and support various matrix multiplication.

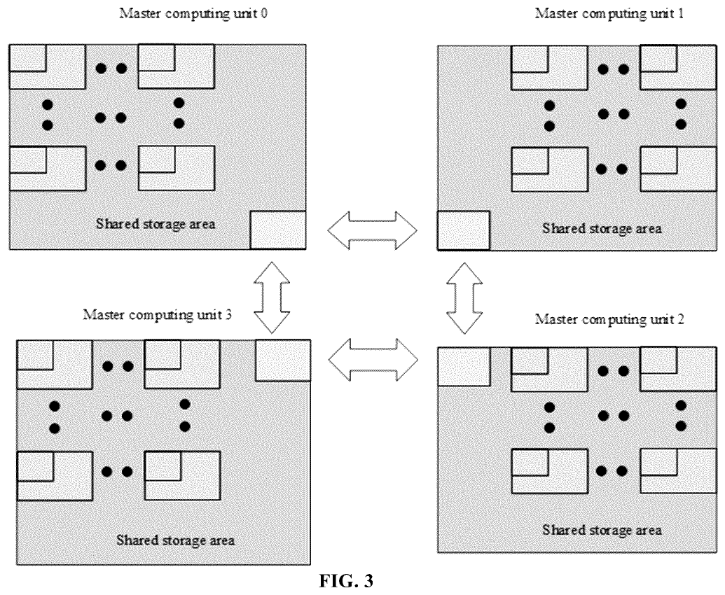

FIG. 3 is an architecture diagram of 2² (which refers to 4) master computing units according to an embodiment of the present disclosure. As shown in FIG. 3, the 4 master computing units (including a master computing unit 0 to a master computing unit 3) are interconnected through a control unit to form a “2*2” computing array. As previously described in combination with FIG. 1 and FIG. 2, the 4 master computing units may be configured to execute matrix multiplication between 4 first matrix blocks and 4 second matrix blocks, and each master computing unit may execute one matrix multiplication task in the 4 matrix multiplication tasks. Further, FIG. 3 also shows M² computing sub-units included in each master computing unit. By allocating the one matrix multiplication task to the M² computing sub-units, parallel pipeline operations may be realized, thereby accelerating the matrix multiplication and satisfying requirements of all kinds of application scenarios.

In an application scenario, the integrated circuit apparatus of the present disclosure may be applied to the field of artificial intelligence, especially to machine learning including a deep neural network. For example, the integrated circuit apparatus of the present disclosure may execute a convolution operation involved in the neural network on a received first matrix and second matrix, where a lot of matrix multiplication are involved. To better understand how the integrated circuit apparatus of the present disclosure is applied to such an application scenario, the following will exemplarily describe the matrix multiplication involved in the convolution operation performed by the integrated circuit apparatus of the present disclosure according to Cannon's algorithm rules.

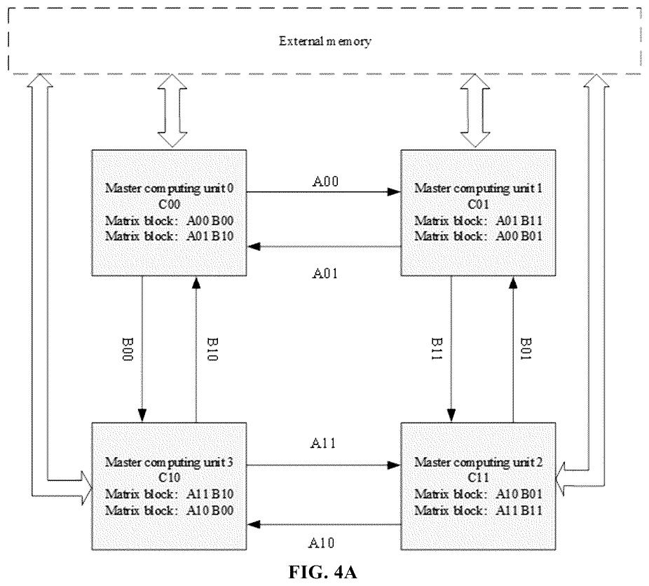

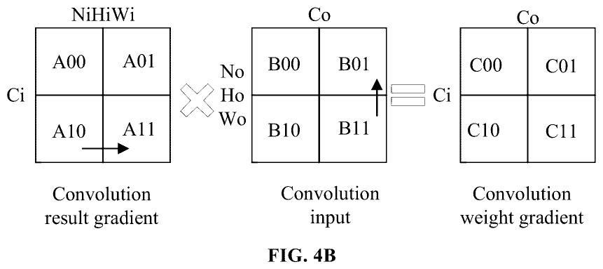

FIG. 4A is a structural diagram of the integrated circuit apparatus of the present disclosure, where the integrated circuit apparatus includes 4 (“2*2”) interconnected master computing units, which are a master computing unit 0 to a master computing unit 3. In addition, to simplify the figure, a plurality of computing sub-units included in the master computing units are not shown in the figure. Further, FIG. 4B exemplarily shows two to-be-computed input matrices and matrix blocks of their computing results. Specifically, two matrices to be used for matrix multiplication are a first matrix including a convolution result gradient and a second matrix including a convolution input respectively. Further, a result matrix obtained after the matrix multiplication of the first matrix and the second matrix is a convolution weight gradient.

As shown in FIG. 4A, 4 master computing units (each of which the master computing unit 102 in FIG. 1) are numbered in a clockwise sequence as a master computing unit 0, a master computing unit 1, a master computing unit 2, and a master computing unit 3, and these master computing units have been successively connected to form a closed loop (or ring). Specifically, there is a bidirectional communication connection between adjacent master computing units 0 and 1. For example, the master computing units may perform bidirectional communication through a direct memory access (DMA) interface. Similarly, there are two bidirectional communication connections between adjacent master computing units 1 and 2, between adjacent master computing units 2 and 3, and between adjacent master computing units 3 and 0 respectively to execute mutual transfer of matrix blocks under the control of a control unit. Besides, each master computing unit may communicate with an external memory (shown by grid lines in the figure) respectively via an interface unit to acquire matrix block data (the convolution result gradient and the convolution input in this embodiment) required for each respective computing task

As known by those skilled in the art, the convolution weight gradient, as the matrix multiplication result in this embodiment, may be used to update a gradient of a convolution result in forward propagation in the process of neural network back propagation. In an operation scenario, convolution weight gradient computing is equivalent to product accumulation computing between the convolution result gradient (when the matrix is a four-dimensional matrix, dimensions of the matrix may be expressed as NiHiWiCi shown in the figure) as the first matrix in this embodiment and the convolution input (when the matrix is the four-dimensional matrix, the dimensions of the matrix may be expressed as NoHoWoCo shown in the figure) as the second matrix in this embodiment. Here, N represents a sample count, H represents a matrix height, W represents a matrix width, and C represents a channel count. Further, according to rules for matrix multiplication, an input matrix “convolution result gradient” may be expressed as Ci*NiHiWi, and an input matrix “convolution input” may be expressed as NoHoWo*Co. The convolution result gradient and the convolution input perform convolution weight gradient computing (such as multiplication and addition) in the NiHiWi and NoHoWo directions. Finally, an obtained output matrix “convolution weight gradient” may be expressed as Kh*Kw*Ci*Co (where Kh represents a height of the output matrix, Kw represents a width of the output matrix, Ci represents a channel count of the input matrix “convolution result gradient”, and Co represents a channel count of the input matrix “convolution input”). For the sake of brevity, the figure only shows convolution weight gradient computing in a Ci*Co direction, which is the matrix multiplication of the present disclosure.

Based on the above exemplary data placement rules (including, for example, the matrix division method according to the Cannon's algorithm) and the architecture of the four master computing units forming the closed loop, a first matrix “convolution result gradient” and a second matrix “convolution input” stored in the external memory may be divided into four matrix blocks respectively. For the sake of brevity, the four matrix blocks obtained by dividing the first matrix “convolution result gradient” are expressed as A00, A01, A10, and A11 shown in the FIG. 4B. Similarly, the four matrix blocks obtained by dividing the second matrix “convolution input” are expressed as B00, B01, B10, and B11. Similarly, the output matrix “convolution weight gradient”, as the result matrix, may also be divided into four matrices C00, C01, C10, and C11.

Based on the above data block, each master computing unit may respectively execute following formulas (1) to (4) to compute and obtain respective corresponding convolution weight gradients C00, C01, C11, and C10.

C00=A00*B00+A01*B10 (1).

C01=A00*B01+A01*B11 (2).

C11=A10*B01+A11*B11 (3).

C10=A10*B00+A11*B10 (4).

Specifically, the solution of the present disclosure may respectively use the four master computing units 0, 1, 2, and 3 to execute computing tasks corresponding to the formulas (1) to (4) to respectively obtain the C00, C01, C11, and C10. In an operation scenario where the Cannon's algorithm is used to execute the above multiplication of the matrix blocks, positions of A10 and A11 of the input matrix “convolution result gradient” shown in FIG. 4B are exchanged according to rules of the Cannon's algorithm, and positions of B01 and B11 of the input matrix “convolution input” are exchanged, as shown by arrows in FIG. 4B.

As mentioned before, each master computing unit may receive one corresponding first matrix block and one corresponding second matrix block from the external memory and execute corresponding matrix multiplication computing. For example, the master computing unit 0 may receive one first matrix block “A00” of the first matrix “convolution result gradient” and one second matrix block “B00” of the second matrix “convolution input” from the external memory through the interface unit, and execute its first matrix multiplication sub-task (A00*B00), which is a part of the matrix multiplication task, according to the formula (1), where “*” represents the matrix multiplication. Similarly, the master computing unit 1 receives one corresponding first matrix block and one corresponding second matrix block (A01 and B11) through the interface unit, and executes its first matrix multiplication task (A01*B11) according to the formula (2). Similarly, the master computing unit 2 and 3 respectively receive one first matrix block and one second matrix block, which are (A10 and B01) and (A11 and B10) respectively, through the interface unit, and execute respective first matrix multiplication tasks (A10*B01) and (A11*B10) respectively according to the formula (3) and the formula (4).

After receiving data of the matrix block from the external memory and executing the matrix multiplication task, each master computing unit may receive another first matrix block and second matrix block from an interconnected master computing unit. As mentioned above, each master computing unit of the present disclosure may use the bidirectional communication connection to send part of matrix block data received from the external memory to an adjacent master computing unit respectively as corresponding matrix block data of another (or second) matrix multiplication task of the adjacent master computing unit.

As mentioned above, obtaining “C00” may be seen as a matrix multiplication task of the master computing unit 0. According to the formula (1), another first matrix block and second matrix block required by completing a second matrix multiplication task in the “C00” matrix multiplication task are “A01” and “B10”. Further, it may be seen from FIG. 4A that the master computing unit 1 that is adjacent to the master computing unit 0 may send the first matrix block “A01” previously received from the external memory to the master computing unit 0. Correspondingly, the master computing unit 3 that is adjacent to the master computing unit 0 may send the first matrix block B10 previously received from the external memory to the master computing unit 0. Therefore, the master computing unit 0 may complete its second matrix multiplication task by executing matrix multiplication on the received matrix block data “A01” and “B10”. Similarly, the master computing units 1, 2, and 3 may also use the bidirectional communication connection to receive the matrix block data sent by the adjacent master computing unit, which is the corresponding one first matrix block and one second matrix block, such as (“A00” and “B01”), (“All” and “B11”), and (“A10” and “B00”) shown in the figure. Next, each master computing unit may execute its respective second matrix multiplication task according to the formulas (1) to (4), and obtain its respective related matrix multiplication result by summing intermediate results of the first and the second matrix multiplication tasks, which is the convolution weight gradient C00, C01, C11, and C10 in this embodiment, thereby completing respective matrix multiplication tasks.

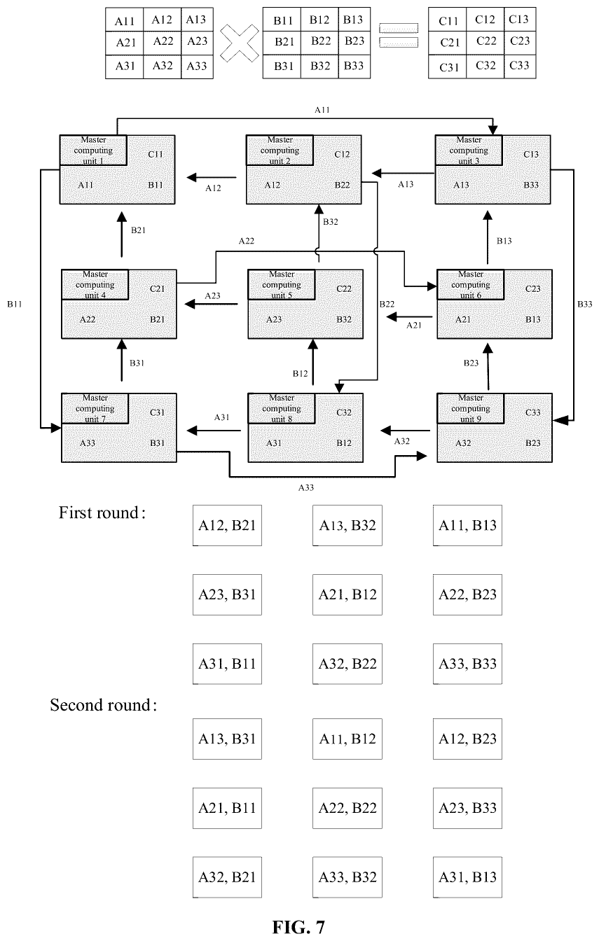

It may be seen from the above descriptions in combination with FIG. 4A and FIG. 4B that each master computing unit of the present disclosure is only required to receive part of matrix block data from the external memory, and another part of matrix block data is received by using a high-speed communication bus among the master computing units. Thus, the solution of the present disclosure significantly reduces data interaction between the master computing unit and the external memory, thereby apparently decreasing the amount of data transfer of on-chip and off-chip I/O and overcoming the I/O bottleneck caused by the bandwidth limitation. It is required to be noted that the formation of the closed loop by the four master computing units shown in FIG. 4A is only exemplary rather than restrictive. According to specific application scenarios, those skilled in the art may prearrange an appropriate number of other master computing units to form a processing formation and a data transfer loop, as shown in FIG. 7 (which will be described in detail later).

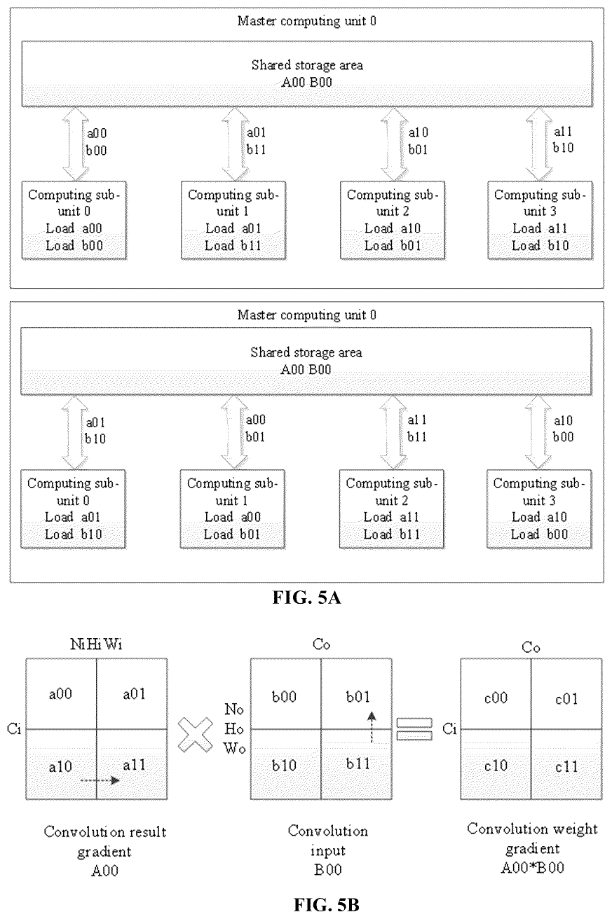

As mentioned above, the matrix multiplication of the present disclosure may be executed by the plurality of computing sub-units in each master computing unit. Based on such setting of the plurality of computing sub-units, the first matrix block and the second matrix block of the present disclosure may be further divided to a plurality of first matrix sub-units and a plurality of second matrix sub-units, and each matrix multiplication task (such as the formula (1), (2), (3) or (4)) may be divided to a plurality of matrix multiplication sub-tasks corresponding to each computing sub-unit in the plurality of computing sub-units. Based on this, based on its related matrix multiplication sub-tasks, each computing sub-unit may read one corresponding first matrix sub-block and one corresponding second matrix sub-block from the shared storage area to execute matrix operations. For a better understanding, the following will discuss how each computing sub-unit completes its respective corresponding matrix multiplication sub-tasks according to rules of the Cannon's algorithm with reference to FIG. 5A and FIG. 5B.

FIG. 5A and FIG. 5B are structural block diagrams where “2*2” computing sub-units are used for convolution matrix multiplication according to embodiments of the present disclosure. For the sake of facilitate description and understanding, the following describes that the master computing unit 0 performs its first matrix multiplication task “A00*B00”, which is involved in the above convolution weight gradient computing, with reference to FIG. 5A and FIG. 5B.

As shown in FIG. 5A, the master computing unit 0 includes the shared storage area and four computing sub-units sequentially numbered 0, 1, 2, and 3 (each of which is the computing sub-unit in FIG. 2). During matrix multiplication, each computing sub-unit may receive (or load) matrix data of its respective first matrix sub-block and second matrix sub-block from the shared storage area. Specifically, according to respective related matrix multiplication sub-tasks, each computing sub-unit in FIG. 5A receives one first matrix sub-block and one second matrix sub-block from the shared storage area and executes a corresponding operation to obtain one intermediate sub-result. By repeating the above step, each computing sub-unit may obtain another intermediate sub-result. Finally, by summing the above two intermediate sub-results, an intermediate result for its matrix multiplication sub-tasks is obtained.

As shown in FIG. 5B, the first matrix block “convolution result gradient” A00 (which is, for example, a four-dimensional matrix and is represented as Ci*NiHiWi) and the second matrix block “convolution input” B00 (which is, for example, the four-dimensional matrix and is represented as NoHoWo*Co) stored in the shared storage area are used as two pieces of input data to perform the first matrix multiplication task “convolution weight gradient” (A00*B00) of the master computing unit 0 (For the purpose of simplification, only the Ci*Co direction is shown). Therefore, the A00 may be divided to four first matrix sub-blocks a00, a01, a10, and all according to the Cannon's algorithm, the B00 may be divided to four second matrix sub-blocks b00, b01, b10, and bll, and these eight matrix sub-blocks are stored in the shared storage area. Further, according to the Cannon's algorithm, a result C00 of the output matrix(A00*B00) may also be divided to four sub-blocks c00, c01, c10, and c11. Based on this, c00, c01, c11, and c10 may be obtained through following formulas (5) to (8) according to operations rules for the matrix multiplication in the Cannon's algorithm.

c00=a00* b00+a01*b10 (5).

c01=a00* b01+a01*b11 (6).

c11=a10*b01+a11*b11 (7).

c10=a10*b00+a11*b10 (8).

According to the solution of the present disclosure, the four computing sub-units 0, 1, 2, and 3 shown in FIG. 5A may respectively execute computing in the formulas (5) to (8). In other words, the four computing sub-units 0, 1, 2 and 3 respectively execute respective matrix multiplication sub-tasks to obtain corresponding c00, c01, c11, and c10. Taking a matrix multiplication sub-task that obtains the c00 as an example, matrix sub-blocks executing the computing sub-unit 0 of the matrix multiplication sub-task include a00, b00, a01, and b10. Similarly, for a matrix multiplication sub-task that obtains the c11, matrix sub-blocks executing the computing sub-unit 2 of the matrix multiplication sub-task are a10, b01, a11, and b11.

Similar to the description with reference to FIG. 2, when the Cannon's algorithm is used for computing, positions of a10 and all of the “convolution result gradient” A00 shown in the left of FIG. 5B may be exchanged, and positions of b01 and bll of the “convolution input” B00 may be exchanged. Therefore, the first and the second matrix sub-blocks of the computing sub-unit 1 that executes the matrix multiplication sub-task obtaining the c01 are a00, b01, a01, and bl 1, and the first and the second matrix sub-blocks of the computing sub-unit 3 that executes the matrix multiplication sub-task obtaining the c01 are a10, b00, a11, and b10.

As shown in the top picture of FIG. 5A, each of the four computing sub-units may receive respective first and second matrix sub-blocks from the shared storage area. Taking the computing sub-unit 0 as an example, the computing sub-unit 0 may load matrix sub-blocks (a00 and b00) from the shared storage area to execute matrix multiplication computing of (a00*b00). Next, as shown in the bottom of FIG. 5A, the computing sub-unit 0 may continue to load matrix sub-blocks (a01 and b10) from the shared storage area to execute matrix multiplication computing of (a01*b10). Finally, by adding computing results of (a00*b00) and (a01*b10), the computing sub-unit 0 completes its related matrix multiplication sub-tasks. The computing sub-units 1, 2, and 3 also execute operations similar to that of the computing sub-unit 0 to complete respective matrix multiplication sub-tasks.

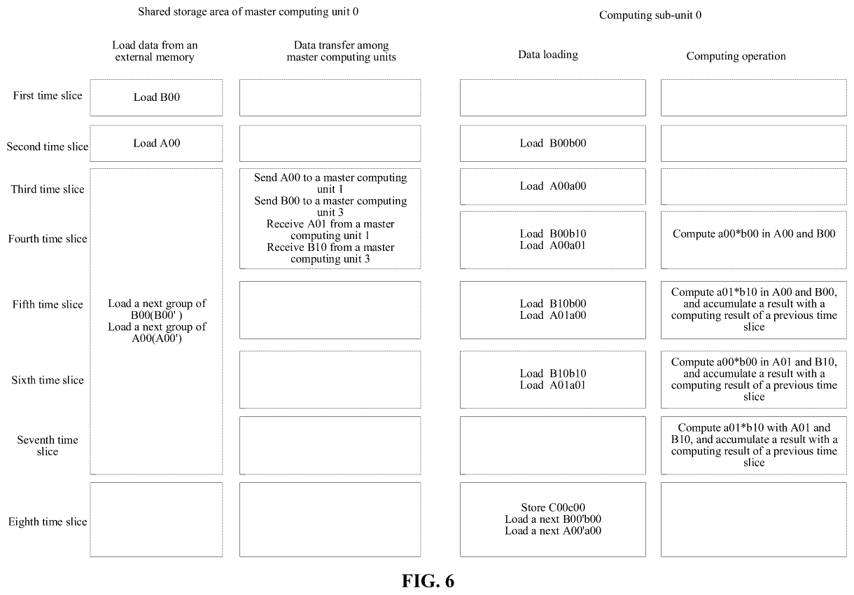

Based on the above description, those skilled in the art may understand that a computing result of each matrix multiplication sub-task in the first matrix multiplication task (such as A00*B00) of the master computing unit 0 is just an intermediate sub-result. Therefore, it is still required to further complete the plurality of matrix multiplication sub-tasks corresponding to the second matrix multiplication task (such as A01*B10) to obtain another intermediate result, so that a final computing result of the matrix multiplication task C00 related to the master computing unit 0 shown in FIG. 5B may be obtained by summing the two intermediate results. Specifically, the computing sub-unit 0, for example, may execute matrix multiplication sub-tasks corresponding to the first matrix multiplication task (A00*B00) according to the formula (5), and set the obtained c00 as a first sub-c00₁. Next, the computing sub-unit 0 is used to execute matrix multiplication sub-tasks corresponding to the second matrix multiplication task (A01*B10) of the C00 to obtain a second sub-c00₂. Finally, the sub-c00₁ and the sub-c00₂ are summed to obtain the matrix block c00 in the outputmatrix block C00. Considering that there are two parts of addition operations in a right side of the formula (5), and c00₂ is obtained by adding two intermediate results, c001 may be added with a first intermediate result and a second intermediate result of c002 sequentially to obtain the matrix sub-block c00. Specific operations will be described with reference to computing operation arrays of a sixth time slice and a seventh time slice in FIG. 6.

By executing operations similar to that of the computing sub-unit 0, the computing sub-units 1, 2, and 3 may respectively obtain the matrix sub-blocks c01, c11, and c10 in the C00. As such, the four matrix sub-blocks c00, c01, c11, and c10 shown in the right side of FIG. 5B constitute the output matrix block C00 obtained by executing the matrix multiplication task by the master computing unit 0. Since intermediate computing results (such as c00, c01, c11, and c10) of each computing sub-unit may be stored in the shared storage area of corresponding master computing units instead of stored in the external memory, the solution of the present disclosure may decrease the data exchange between the master computing unit and the external memory, thus reducing the I/O bottleneck caused by the external bandwidth limitation.

Further, according to the above description, those skilled in the art may understand that the four computing sub-units included in the master computing unit in FIG. 5A are only exemplary rather than restrictive. According to different application scenarios, those skilled in the art, based on the teaching of the present disclosure, may preset a different number of computing sub-units, or enable or disable a different number of computing sub-units, to execute the matrix multiplication computing according to the Cannon's algorithm.

FIG. 6 shows a pipeline operation performed by the integrated circuit apparatus (including the master computing unit and its computing sub-unit) according to an embodiment of the present disclosure. Especially, taking a case where the master computing unit 0 and the computing sub-unit 0 shown in FIG. 5A and FIG. 5B execute the convolution operation as an example, FIG. 6 shows data transfer and specific operations (including, for example, data loading and matrix multiplication operations) among the master computing unit 0, the computing sub-unit 0, the external memory, and the shared storage area in chronological order.

Specifically, FIG. 6 shows a pipeline operation where, during a period from a first time slice to an eighth time slice, the master computing unit 0 and its computing sub-unit 0 execute corresponding data receiving, sending, loading, or matrix multiplication operations in each time slice to finally obtain the matrix sub-block C00 in the output matrix block c00 of the convolution weight gradient in the form of rows. Further, FIG. 6 shows four types of operations executed in each time slice in the form of columns. As shown in the figure, a first column represents loading data from the external memory (such as a double data rate (DDR) memory); for example, the first column represents receiving the first matrix block and the second matrix block discussed in the present disclosure from the external memory. A second column represents data transfer among the master computing units; for example, the shared storage area of the master computing unit 0 sends the first and the second matrix blocks to the adjacent master computing units 1 and 3, and receives the first and the second matrix blocks from the master computing units 1 and 3 as operation data for executing the second matrix multiplication task by the master computing unit 0. A third column represents data loading of the computing sub-unit 0. A fourth column represents the matrix multiplication executed in the computing sub-unit 0. According to the time slice and operation division described above, the master computing unit 0 executes a corresponding operation in a corresponding time slice. For example, in the first time slice, the shared storage area of the master computing unit 0 only stores B00 received from the external memory (from off-chip). For another example, in a second time slice, the shared storage area of the master computing unit receives A00 from the external memory, and the computing sub-unit 0 loads b00 in the B00 from the shared storage area.

To effectively use on-chip I/O and computing resources, on-chip operations of the present disclosure may be ping-pong pipeline operations. Specifically, according to the solution of the present disclosure, on-chip storage resources may be divided to two parts, “ping” and “pong”. In an embodiment, when ping storage resources are used to load the data, pong storage resources are used to execute the matrix multiplication. On the contrary, when the ping storage resources are used to execute the matrix multiplication, the pong storage resources are used to load the data. Based on this resource allocation, the master computing unit of the present disclosure may execute parallel ping-pong pipeline operations.

It may be seen from the figure that in the first time slice, the master computing unit 0 loads the B00 from the external memory and stores the B00 in the pong part of the shared storage area. In the second time slice, the master computing unit 0 loads A00 from the external memory and stores the A00 in the ping part of the shared storage area. Meanwhile, the b00 of the B00 may be loaded to the computing sub-unit 0 in parallel. In a third time slice, a00 of the A00 may be loaded to the computing sub-unit 0. Besides, during the third time slice and a fourth time slice, the master computing unit 0 sends the A00 to the interconnected master computing unit 1 through the control unit and sends the B00 to the interconnected master computing unit 3. Meanwhile, the master computing 10 unit 0 receives A01 from the master computing unit 1 and B10 from the master computing unit 3 through the control unit.

In a data loading column of the fourth time slice, b10 of the B00 and a01 of the A00 may be loaded to the computing sub-unit 0; meanwhile, in a matrix multiplication operation column of the fourth time slice, a00*b00 of the A00 and the B00 is computed to obtain an intermediate sub-result. In a data loading column of a fifth time slice, b00 of the B10 and a00 of the A01 may be loaded to the computing sub-unit 0; meanwhile, in a computing operation column of the fifth time slice, a01*b10 of the A00 and the B00 is computed to obtain an intermediate sub-result, and the intermediate sub-result is accumulated with the intermediate sub-result of the previous time slice to obtain an intermediate result of the fifth time slice. In a data loading column of a sixth time slice, b10 of the B10 and a01 of the A01 may be loaded to the computing sub-unit 0; meanwhile, in a matrix multiplication operation column of the sixth time slice, a00*b00 of the A01 and the B10 is computed to obtain an intermediate sub-result, and the intermediate sub-result is accumulated with the intermediate sub-result of the previous time slice to obtain an intermediate result of the sixth time slice. In a matrix multiplication operation column of a seventh time slice, a01*b10 of the A01 and the B10 is computed to obtain an intermediate sub-result, and the intermediate sub-result is accumulated with the intermediate sub-result of the previous time slice to obtain the matrix sub-block c00 of the output matrix block C00.

During the data loading and computing from the third time slice to the seventh time slice, the pong part of the on-chip storage resources is used to receive a next group of B00 (B00') and A00 (A00′) from the external memory to enable the master computing unit 0 to execute the first matrix multiplication task. Next, from an eighth time slice, the computing sub-unit 0 stores c00 of C00 output from the previous time slice to the shared storage area. Meanwhile, b00 of the next group of B00' and a00 of the next group of A00′ are loaded to the computing sub-unit 0 to be computed at a next time slice (which is not shown).

Similarly, the computing sub-units 1, 2, and 3 of the master computing unit 0 and different master computing units and corresponding computing sub-units also execute similar operations as the above eight time slices to obtain corresponding matrix locks of respective output matrices. Since the input matrix “convolution result gradient” and “convolution input” may have a multi-dimensional structure, computing results of three directions NHW may be computed first and then accumulated. Then, the above computing is executed cyclically in the Ci and Co dimensions of two input matrices to obtain the computing result of the output matrix “convolution weight gradient”.

FIG. 7 shows a structural architecture diagram of “3*3” master computing units according to an embodiment of the present disclosure. It may be seen from FIG. 7 that the “3*3” master computing units may execute the matrix multiplication shown in the above of FIG. 7 by forming a computing array and a data transfer loop. Different from the operations of the above“2*2” master computing units, the “3*3” master computing units are required to execute data transfer twice among adjacent master computing units, but the “2*2” master computing units are required to execute the data transfer once. In other words, for the solution of the present disclosure, “N*N” master computing units are required to execute data transfer or exchange for (N−1) times among adjacent master computing units. For the sake of understanding, the lower part of FIG. 7 shows first matrix block data and second matrix block data obtained by each master computing unit after a first round of data transfer and a second round of data transfer. Taking a master computing unit 5 as an example, after obtaining a first matrix block “A23” and a second matrix block “B32” from the external memory, in the first round of data transfer, the master computing unit 5 receives another first matrix block “A21” from a master computing unit 6 and a second matrix block “B12” from a master computing unit 8 to execute a corresponding matrix multiplication task “A21*B12”. Then, in the second round of data transfer, the master computing unit 5 receives another first matrix block “A22” from the master computing unit 6 and a second matrix block “B22” from the master computing unit 8 to execute a corresponding matrix multiplication task “A22*B22”. It may be seen from the architecture and the matrix division shown in FIG. 7 that the “3*3” master computing units may support dividing two big matrices to two “3*3” matrix blocks to execute the matrix multiplication.

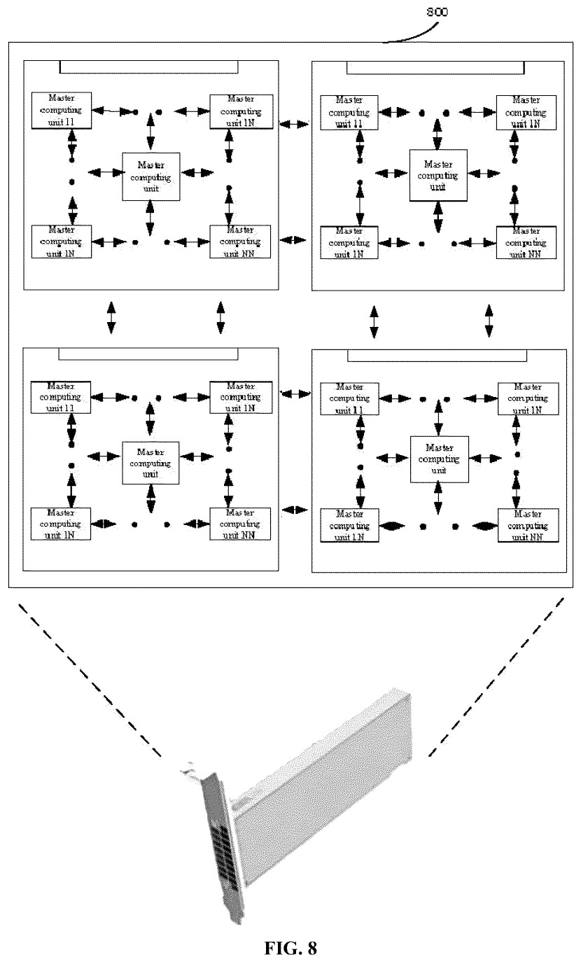

FIG. 8 shows a board card 800 used for matrix multiplication according to an embodiment of the present disclosure. As shown in FIG. 8, the board card includes four integrated circuit apparatuses described with reference to FIG. 1 to FIG. 7. It may be understood that, although four integrated circuit apparatuses are shown here, those skilled in the art may arrange interconnected P² integrated circuit apparatuses according to the teaching of the present disclosure, where P is a positive integer greater than or equal to 2. By using a board card including P² integrated circuit apparatuses, the solution of the present disclosure may execute matrix multiplication on a first matrix and a second matrix that are divided to “P²*N²*M²” matrix blocks respectively.

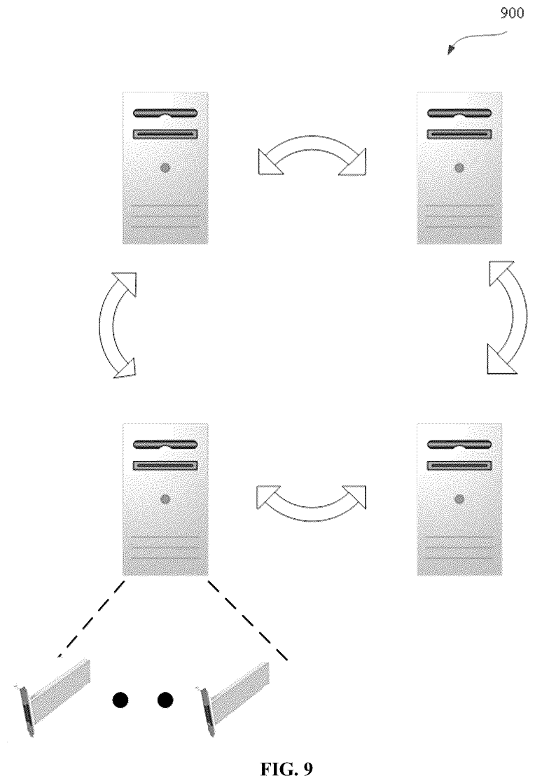

FIG. 9 shows a computing system 900 used for matrix multiplication according to an embodiment of the present disclosure. As shown in FIG. 9, the computing system 900 includes four servers or hosts, where one or a plurality of board cards shown in FIG. 8 are arranged in each host to support matrix multiplication of super-large matrices. Specifically, when two super-large matrices are multiplied, the two matrices may be divided to four matrix blocks respectively according to the computing system of FIG. 9. Next, each matrix block is further divided according to the number of board cards on each host. Steps may be continued by analogy until the super-large matrices involved in the matrix multiplication are divided to matrix multiplication operation granularity supported by the computing sub-unit of the present disclosure.

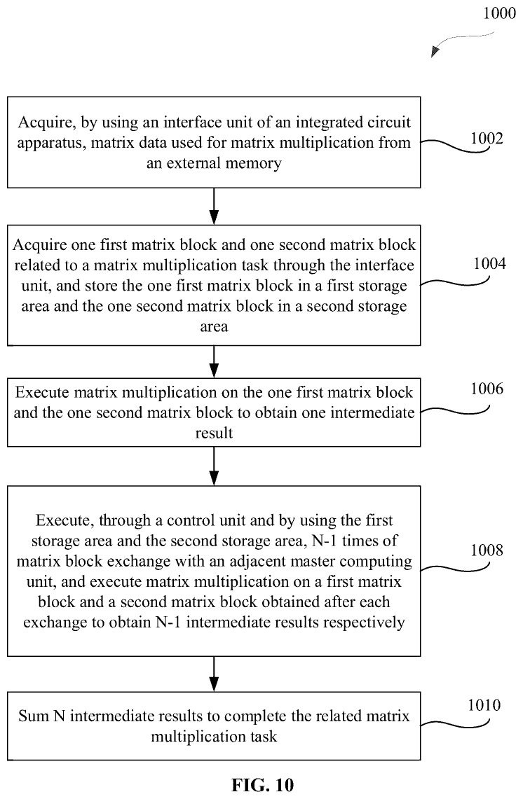

FIG. 10 shows a flowchart of a method 1000 for performing matrix multiplication according to an embodiment of the present disclosure. With reference to the above description, it may be understood that the method 1000 may be executed by the integrated circuit apparatus of the present disclosure, so the description of the integrated circuit chip is also applicable to the following description of the method 1000.

As shown in FIG. 10, in a step 1002, the method 1000 acquires, by using an interface unit of the integrated circuit apparatus, matrix data used for the matrix multiplication from an external memory. In an embodiment, here, the matrix data includes a first matrix and a second matrix, where the first matrix is divided to N² first matrix blocks, the second matrix is divided to N² second matrix blocks, and the matrix multiplication of the first matrix and the second matrix includes N² matrix multiplication tasks based on the N² first matrix blocks and the N² second matrix blocks, where N is a positive integer greater than or equal to 2. Next, for each master computing unit, the method 1000 executes steps 1004-1010 to complete a matrix multiplication task of a master computing unit.

Specifically, in a step 1004, the method 1000 acquires one first matrix block and one second matrix block related to the matrix multiplication task through the interface unit and stores the one first matrix block in a first storage area and the one second matrix block in a second storage area. Next, in a step 1006, the method 1000 executes matrix multiplication on the one first matrix block and the one second matrix block to obtain one intermediate result. Hereafter, in a step 1008, the method 1000 executes, through a control unit and by using the first storage area and the second storage area, N−1 times of matrix block exchange with an adjacent master computing unit and executes matrix multiplication on a first matrix block and a second matrix block obtained after each exchange to obtain N−1 intermediate results respectively. Finally, in a step 1010, the method 1000 sums N intermediate results to complete the related matrix multiplication task.

For the sake of simplicity, the method of the present disclosure is described only in combination with FIG. 10. According to the disclosed content of the present disclosure, those skilled in the art may also conceive that the method 1000 of the present disclosure may include more steps, and the execution of these steps may realize various operations described above in combination with FIGS. 1-9, which will not be repeated herein.

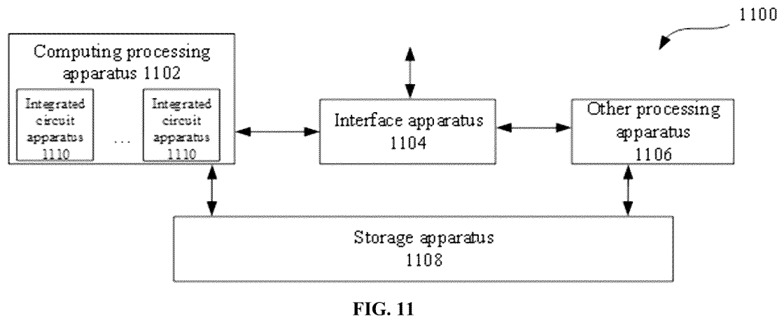

FIG. 11 shows a structural diagram of a combined processing apparatus 1100 according to an embodiment of the present disclosure. As shown in FIG. 11, the combined processing apparatus 1100 includes a computing processing apparatus 1102, an interface apparatus 1104, other processing apparatus 1106, and a storage apparatus 1108. According to different application scenarios, the computing processing apparatus may include one or more integrated circuit apparatuses 1110. The integrated circuit apparatus may be configured to execute the matrix multiplication described with reference to FIGS. 1-10.

In different embodiments, the computing processing apparatus of the present disclosure may be configured to perform an operation specified by a user. In an exemplary application, the computing processing apparatus may be implemented as a multi-core artificial intelligence processor. Similarly, one or a plurality of computing apparatuses included in the computing processing apparatus may be implemented as an artificial intelligence processor core or part of a hardware structure of the artificial intelligence processor core. When the plurality of computing apparatuses are implemented as artificial intelligence processor cores or part of hardware structures of the artificial intelligence processor cores, the computing processing apparatus of the present disclosure may be regarded as having a single-core structure or an isomorphic multi-core structure.

In an exemplary operation, the computing processing apparatus of the present disclosure may interact with other processing apparatuses through the interface apparatus to jointly complete the operation specified by the user. According to different implementations, other processing apparatuses of the present disclosure may include one or more types of general and/or dedicated processors, including a central processing unit (CPU), a graphics processing unit (GPU), an artificial intelligence processor, and the like. These processors include but are not limited to a digital signal processor (DSP), an application specific integrated circuit (ASIC), a field-programmable gate array (FPGA), or other programmable logic components, discrete gate or transistor logic components, discrete hardware components, and the like. Moreover, the number of the processors may be determined according to actual requirements. As described above, the computing processing apparatus of the present disclosure may be regarded as having the single-core structure or the isomorphic multi-core structure. However, when the computing processing apparatus and other processing apparatus are considered together, the computing processing apparatus and other processing apparatus may be regarded as forming a heterogeneous multi-core structure.

In one or a plurality of embodiments, other processing apparatus may serve as an interface between the computing processing apparatus (which may be embodied as an artificial intelligence operation apparatus such as a neural network operation apparatus) of the present disclosure and external data and controls. Other processing apparatus may perform basic controls that include but are not limited to moving data, and starting and/or stopping the computing apparatus. In other embodiments, other processing apparatus may also cooperate with the computing processing apparatus to jointly complete an operation task.

In one or a plurality of embodiments, the interface apparatus may be used to transfer data and a control instruction between the computing processing apparatus and other processing apparatus. For example, the computing processing apparatus may acquire input data from other processing apparatus via the interface apparatus and write the input data to an on-chip storage apparatus (or called a memory) of the computing processing apparatus. Further, the computing processing apparatus may acquire the control instruction from other processing apparatus via the interface apparatus and write the control instruction to an on-chip control cache of the computing processing apparatus.

Alternatively or optionally, the interface apparatus may further read data in the storage apparatus of the computing processing apparatus and then transfer the data to other processing apparatus.

Additionally, or optionally, the combined processing apparatus of the present disclosure may further include a storage apparatus. As shown in the figure, the storage apparatus may be connected to the computing processing apparatus and other processing apparatus respectively. In one or a plurality of embodiments, the storage apparatus may be used to save data of the computing processing apparatus and/or other processing apparatus. For example, the data may be data that may not be fully saved in internal or on-chip storage apparatus of the computing processing apparatus or other processing apparatus.

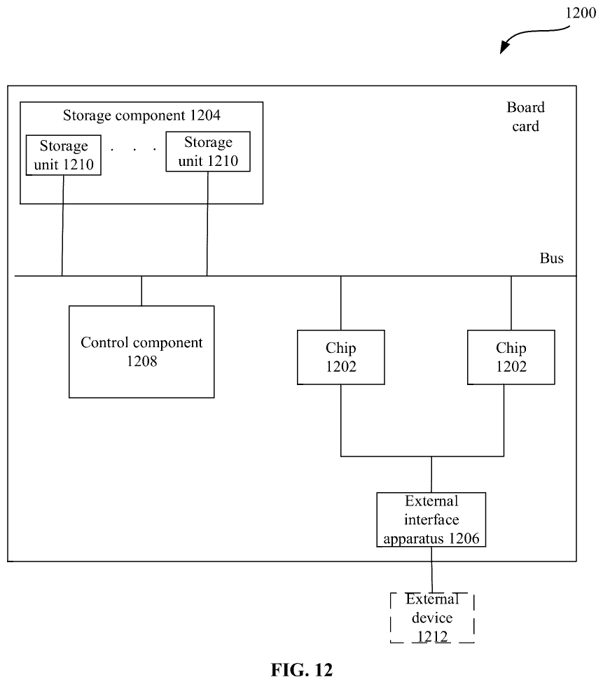

In some embodiments, the present disclosure also discloses a chip (such as a chip 1202 shown in FIG. 12). In an embodiment, the chip is a system on chip (SoC) and integrates one or a plurality of combined processing apparatuses shown in FIG. 11. The chip may be connected to other related components through an external interface apparatus (such as an external interface apparatus 1206 shown in FIG. 12). The related components may be, for example, a camera, a monitor, a mouse, a keyboard, a network card, or a WIFI interface. In some application scenarios, the chip may integrate other processing units (such as a video codec) and/or an interface unit (such as a dynamic random access memory (DRAM) interface), and the like. In some embodiments, the present disclosure also discloses a chip package structure, including the chip. In some embodiments, the present disclosure also discloses a board card, including the chip package structure. The following will describe the board card in detail in combination with FIG. 12.

FIG. 12 is a structural diagram of a board card 1200 according to an embodiment of the present disclosure, where the board card shown in FIG. 8 may be seen as a concrete form of the board card 1200. As shown in FIG. 12, the board card includes a storage component 1204 used for storing data. The storage component 1204 includes one or a plurality of storage units 1210. The storage component may be connected to and may transfer data to a control component 1208 and the chip 1202 through a bus. Further, the board card further includes an external interface apparatus 1206, which is configured to implement data relay or transfer between the chip (or the chip in the chip package structure) and an external device 1212 (such as a server or a computer, and the like). For example, to-be-processed data may be transferred from the external device to the chip through the external interface apparatus. For another example, a computing result of the chip may be sent back to the external device through the external interface apparatus. According to different application scenarios, the external interface apparatus may have different interface forms. For example, the external interface apparatus may adopt a standard peripheral component interface express (PCIe) interface.

In one or a plurality of embodiments, the control component in the board card of the present disclosure may be configured to regulate and control a state of the chip. As such, in an application scenario, the control component may include a micro controller unit (MCU), which may be used to regulate and control a working state of the chip.

According to descriptions in combination with FIG. 11 and FIG. 12, those skilled in the art may understand that the present disclosure also discloses an electronic device or apparatus, which may include one or a plurality of the board cards, one or a plurality of the chips, and/or one or a plurality of the combined processing apparatuses.

According to different application scenarios, the electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograph. The electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be further used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device to complete unified management, scheduling, and collaborative work of terminal-cloud integration or cloud-edge-terminal integration.

It is required to be explained that, for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that, for a part that is not described in detail in a certain embodiment of the present disclosure, reference may be made to related descriptions in other embodiments.

In terms of specific implementations, according to the present disclosure and under the teaching of the present disclosure, those skilled in the art may understand that several embodiments disclosed in the present disclosure may be implemented through other methods that are not disclosed in the present disclosure. For example, for units in the electronic device or apparatus embodiment, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the direct or indirect coupling relates to a communication connection using an interface, where the communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected for achieving the purpose of the solution described in the embodiments of the present disclosure. Additionally, in some scenarios, a plurality of units in the embodiments of the present disclosure may be integrated into one unit, or each of the units may be physically separated.

In some implementation scenarios, the integrated unit may be implemented in the form of a software program unit. When the integrated unit is implemented in the form of the software program unit and sold or used as an independent product, the integrated unit may be stored in a computer-readable memory. Based on such understanding, if the solution of the present disclosure is embodied in the form of a software product (such as a computer-readable storage medium), the software product may be stored in a memory. The software product may include several instructions used to enable a computer device (which may be a personal computer, a server, or a network device, and the like) to perform part or all steps of the method of the embodiments of the present disclosure. The foregoing memory includes but is not limited to an USB, a flash disk, a read only memory (ROM), a random access memory (RAM), a mobile hard disk, a magnetic disk, or an optical disc, and other media that may store a program code.

In some other implementation scenarios, the integrated unit may be implemented in the form of hardware. The hardware may be a specific hardware circuit, which may include a digital circuit and/or an analog circuit. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a central processing unit (CPU), a graphics processing unit (GPU), a field-programmable gate array (FPGA), a digital signal processor (DSP), and an application-specific integrated circuit (ASIC), and the like. Further, the storage unit or the storage apparatus may be any appropriate storage medium (including a magnetic storage medium or a magneto-optical storage medium, and the like), such as an RRAM (resistive random access memory), a dynamic random access memory (DRAM), a static random access memory (SRAM), an enhanced dynamic random access memory (EDRAM), a high bandwidth memory (HBM), a hybrid memory cube (HMC), the ROM, and the RAM, and the like.

Based on the above sufficient disclosure of the present disclosure, those skilled in the art may understand that the present disclosure further discloses technical solutions recorded in following articles.

Article A1. An integrated circuit apparatus for matrix multiplication, including:
an interface unit configured to acquire matrix data used for the matrix multiplication from an external memory, where the matrix data includes a first matrix and a second matrix, where the first matrix is divided to N² first matrix blocks, the second matrix is divided to N² second matrix blocks, and matrix multiplication of the first matrix and the second matrix includes N² matrix multiplication tasks based on the N² first matrix blocks and the N² second matrix blocks, where N is a positive integer greater than or equal to 2;
and N² master computing units, where the N² master computing units are connected sequentially to form a data transfer loop, where each master computing unit is configured to execute one corresponding matrix multiplication task in the N² matrix multiplication tasks and includes:
   a plurality of storage areas, configured to store matrix blocks used for executing the matrix multiplication tasks and intermediate results; and
   a control unit, configured to execute matrix block exchange with an adjacent master computing unit,
   where in executing the one corresponding matrix multiplication task, each master computing unit is configured to:
      acquire one first matrix block and one second matrix block related to the matrix multiplication task through the interface unit, and store the one first matrix block in a first storage area and the one second matrix block in a second storage area;
   execute matrix multiplication on the one first matrix block and the one second matrix block to obtain one intermediate result;
   execute N−1 times of matrix block exchange with the adjacent master computing unit through the control unit and by using the first storage area and the second storage area, and execute matrix multiplication on a first matrix block and a second matrix block obtained after each exchange to obtain N−1 intermediate results respectively; and
   sum N intermediate results to complete the related matrix multiplication task.

Article A2. The integrated circuit apparatus of article Al, where each master computing unit includes M² computing sub-units, and the first matrix block and the second matrix block are respectively divided to M² first matrix sub-blocks and M² second matrix sub-blocks, where one matrix multiplication task includes M² matrix multiplication sub-tasks based on the M² first matrix sub-blocks and the M² second matrix sub-blocks, where each computing sub-unit in the M² computing sub-units is configured to execute one corresponding matrix multiplication sub-task in the M² matrix multiplication sub-tasks, and in executing the one corresponding matrix multiplication sub-task, the computing sub-unit is configured to:
execute following operations for M times to obtain M intermediate sub-results:
   acquire one first matrix sub-block related to the matrix multiplication sub-task from the first storage area and one second matrix sub-block related to the matrix multiplication sub-task from the second storage area;
   execute matrix multiplication on the one first matrix sub-block and the one second matrix sub-block to obtain one intermediate sub-result; and
   sum M intermediate sub-results to complete the related matrix multiplication sub-task.

Article A3. The integrated circuit apparatus of article A2, where the first storage area and the second area are shared storage areas shared by the M² computing sub-units.

Article A4. The integrated circuit apparatus of article A2, where the plurality of storage areas of each master computing unit further include M² private sub-storage areas, where each private sub-storage area is related to one corresponding computing sub-unit and is configured to store an intermediate sub-result.

Article A5. The integrated circuit apparatus of article A2, where the N² master computing units are configured to execute respective related matrix multiplication tasks in parallel, and the M² computing sub-units are configured to execute respective related matrix multiplication sub-tasks in parallel.

Article A6. The integrated circuit apparatus of any one of articles A1-A5, where the first matrix and the second matrix are divided according to Cannon's algorithm rules to obtain the N² first matrix blocks and the N² second matrix blocks.

Article A7. The integrated circuit apparatus of any one of articles A2-A5, where the first matrix block and the second matrix block are divided according to Cannon's algorithm rules to obtain the M² first matrix sub-blocks and the M² second matrix sub-blocks.

Article A8. A board card, including the integrated circuit apparatus of any one of articles A1-A7.

Article A9. The board card of article A8, where when the board card includes P² integrated circuit apparatuses, the integrated circuit apparatuses are connected sequentially to form a data transfer loop to execute matrix multiplication on a first matrix and a second matrix that are respectively divided to P²*N²*M² matrix blocks, where P is a positive integer greater than or equal to 2.

Article A10. A computing device, including one or a plurality of board cards of article A8.

Article A11. A computing system, including a plurality of computing devices of article A10, where the plurality of computing devices are interconnected and work together to realize distributed matrix multiplication.

Article A12. A method for matrix multiplication using the integrated circuit apparatus of any one of articles A1-A7, including:
acquiring, by using an interface unit of the integrated circuit apparatus, matrix data used for the matrix multiplication from an external memory, where the matrix data includes a first matrix and a second matrix, where the first matrix is divided to N² first matrix blocks, the second matrix is divided to N² second matrix blocks, and matrix multiplication of the first matrix and the second matrix includes N² matrix multiplication tasks based on the N² first matrix blocks and the N² second matrix blocks, where N is a positive integer greater than or equal to 2;
executing, by using each master computing unit, following operations:
   acquiring one first matrix block and one second matrix block related to a matrix multiplication task through the interface unit, and storing the one first matrix block in a first storage area and the one second matrix block in a second storage area;
   executing matrix multiplication on the one first matrix block and the one second matrix block to obtain one intermediate result;
   executing N−1 times of matrix block exchange with an adjacent master computing unit through a control unit and by using the first storage area and the second storage area, and executing matrix multiplication on a first matrix block and a second matrix block obtained after each exchange to obtain N−1 intermediate results respectively; and
   summing N intermediate results to complete the related matrix multiplication task.

Article A13. The method of article A12, where the computing sub-unit is further used to execute following operations:
executing following operations for M times to obtain M intermediate sub-results:
   acquiring one first matrix sub-block related to the matrix multiplication sub-task from the first storage area and one second matrix sub-block related to the matrix multiplication sub-task from the second storage area;
   executing matrix multiplication on the one first matrix sub-block and the one second matrix sub-block to obtain one intermediate sub-result; and
   summing M intermediate sub-results to complete the related matrix multiplication sub-task.

Article A14. The method of article A13, where the first storage area and the second area are shared storage areas shared by the M² computing sub-units.

Article A15. The method of article A13, where the plurality of storage areas of each master computing unit further include M² private sub-storage areas, where each private sub-storage area is related to one corresponding computing sub-unit and is configured to store an intermediate sub-result.

Article A16. The method of article A13, where the N² master computing units are used to execute respective related matrix multiplication tasks in parallel, and the M² computing sub-units are used to execute respective related matrix multiplication sub-tasks in parallel.

Article A17. The method of any one of articles A12-A16, including dividing the first matrix and the second matrix according to Cannon's algorithm rules to obtain the N² first matrix blocks and the N² second matrix blocks.

Article A18. The method of any one of articles A13-A16, where the first matrix block and the second matrix block are divided according to Cannon's algorithm rules to obtain the M² first matrix sub-blocks and the M² second matrix sub-blocks.

Article A19. A computer program product, including a program instruction used for executing matrix multiplication, where when the program instruction is executed by one or more processors, the method of any one of articles A12-A18 is implemented.

It should be understood that terms such as “first”, “second”, “third”, and “fourth” in claims, specification, and drawings are used for distinguishing different objects rather than describing a specific order. It should be understood that the terms “including” and “comprising” used in the specification and the claims indicate the presence of a feature, an entity, a step, an operation, an element, and/or a component, but do not exclude the existence or addition of one or more other features, entities, steps, operations, elements, components, and/or collections thereof.

It should also be understood that terms used in the specification of the present disclosure are merely for a purpose of describing a particular embodiment rather than limiting the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims of the present disclosure refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

Even though the present disclosure has already shown and described a plurality of embodiments, it is obvious for those skilled in the art that such embodiments are only provided through the method of examples. Those skilled in the art may think of many modifying, altering, and substituting methods without deviating from the thought and spirit of the present disclosure. It should be understood that various alternatives to the embodiments of the present disclosure described herein may be adopted in the practice of the present disclosure. The attached claims are intended to limit the scope of protection of the present disclosure and therefore to cover equivalents or alternatives within the scope of these claims.

1. An integrated circuit apparatus for matrix multiplication, comprising:
an interface unit, configured to acquire matrix data used for the matrix multiplication from an external memory, wherein the matrix data comprises a first matrix and a second matrix, the first matrix is divided to N² first matrix blocks, the second matrix is divided to N² second matrix blocks, and matrix multiplication of the first matrix and the second matrix comprises N² matrix multiplication tasks based on the N² first matrix blocks and the N² second matrix blocks, wherein N is a positive integer greater than or equal to 2; and
N² master computing units connected sequentially to form a data transfer loop, each master computing unit configured to execute one corresponding matrix multiplication task in the N² matrix multiplication tasks and comprising:
a plurality of storage areas configured to store matrix blocks used for executing the matrix multiplication tasks and intermediate results; and
a control unit configured to execute matrix block exchange with an adjacent master computing unit,
wherein in executing the one corresponding matrix multiplication task, each master computing unit is configured to:
acquire one first matrix block and one second matrix block related to the matrix multiplication task through the interface unit, and store the one first matrix block in a first storage area and the one second matrix block in a second storage area;
execute matrix multiplication on the one first matrix block and the one second matrix block to obtain one intermediate result;
execute N−1 times of matrix block exchange with the adjacent master computing unit through the control unit and by using the first storage area and the second storage area, and execute matrix multiplication on a first matrix block and a second matrix block obtained after each exchange to obtain N−1 intermediate results respectively; and
sum N intermediate results to complete the related matrix multiplication task.

2. The integrated circuit apparatus of claim 1, wherein each master computing unit comprises M² computing sub-units, the first matrix block is divided to M² first matrix sub-blocks, and the second matrix block is divided to M² second matrix sub-blocks, wherein one matrix multiplication task comprises M² matrix multiplication sub-tasks based on the M² first matrix sub-blocks and the M² second matrix sub-blocks, wherein each computing sub-unit in the M² computing sub-units is configured to execute one corresponding matrix multiplication sub-task in the M² matrix multiplication sub-tasks, and in executing the one corresponding matrix multiplication sub-task, the computing sub-unit is configured to:
execute following operations for M times to obtain M intermediate sub-results:
acquire one first matrix sub-block related to the matrix multiplication sub-task from the first storage area and one second matrix sub-block related to the matrix multiplication sub-task from the second storage area;
execute matrix multiplication on the one first matrix sub-block and the one second matrix sub-block to obtain one intermediate sub-result; and
sum M intermediate sub-results to complete the related matrix multiplication sub-task.

3. The integrated circuit apparatus of claim 2, wherein the first storage area and the second storage area are shared storage areas shared by the M² computing sub-units.

4. The integrated circuit apparatus of claim 2, wherein the plurality of storage areas of each master computing unit further comprise M² private sub-storage areas, wherein each private sub-storage area is related to one corresponding computing sub-unit and is configured to store an intermediate sub-result.

5. The integrated circuit apparatus of claim 2, wherein the N² master computing units are configured to execute respective related matrix multiplication tasks in parallel, and the M² computing sub-units are configured to execute respective related matrix multiplication sub-tasks in parallel.

6. The integrated circuit apparatus of claim 1, wherein the first matrix and the second matrix are divided according to Cannon's algorithm rules to obtain the N² first matrix blocks and the N² second matrix blocks.

7. The integrated circuit apparatus of claim 2, wherein the first matrix block and the second matrix block are divided according to Cannon's algorithm rules to obtain the M² first matrix sub-blocks and the M² second matrix sub-blocks.

8. A board card, comprising one or more integrated circuit apparatuses of claim 1.

9. The board card of claim 8, wherein when the board card comprises P² integrated circuit apparatuses, the integrated circuit apparatuses are connected sequentially to form a data transfer loop to execute matrix multiplication on a first matrix and a second matrix that are respectively divided to P²*N²*M² matrix blocks, wherein P is a positive integer greater than or equal to 2.

10. A computing device, comprising one or more board cards of claim 8.

11. A computing system, comprising a plurality of computing devices of claim 10, wherein the plurality of computing devices are interconnected and work together to realize distributed matrix multiplication.

12. A method for matrix multiplication using the integrated circuit apparatus of claim 1, comprising:
acquiring, by using an interface unit of the integrated circuit apparatus, matrix data used for the matrix multiplication from an external memory, wherein the matrix data comprises a first matrix and a second matrix, wherein the first matrix is divided to N² first matrix blocks, the second matrix is divided to N² second matrix blocks, and matrix multiplication of the first matrix and the second matrix comprises N² matrix multiplication tasks based on the N² first matrix blocks and the N² second matrix blocks, wherein N is a positive integer greater than or equal to 2;
executing, by using each master computing unit, following operations:
acquiring one first matrix block and one second matrix block related to a matrix multiplication task through the interface unit, and storing the one first matrix block in a first storage area and the one second matrix block in a second storage area;
executing matrix multiplication on the one first matrix block and the one second matrix block to obtain one intermediate result;
executing N−1 times of matrix block exchange with an adjacent master computing unit through a control unit and by using the first storage area and the second storage area, and executing matrix multiplication on a first matrix block and a second matrix block obtained after each exchange to obtain N−1 intermediate results respectively; and
summing N intermediate results to complete the related matrix multiplication task.

13. The method of claim 12, wherein the computing sub-unit is further used to execute following operations:
executing following operations for M times to obtain M intermediate sub-results:
acquiring one first matrix sub-block related to the matrix multiplication sub-task from the first storage area and one second matrix sub-block related to the matrix multiplication sub-task from the second storage area;
executing matrix multiplication on the one first matrix sub-block and the one second matrix sub-block to obtain one intermediate sub-result; and
summing M intermediate sub-results to complete the related matrix multiplication sub-task.

14. The method of claim 13, wherein the first storage area and the second storage area are shared storage areas shared by the M² computing sub-units.

15. The method of claim 13, wherein the plurality of storage areas of each master computing unit further comprise M² private sub-storage areas, wherein each private sub-storage area is related to one corresponding computing sub-unit and is configured to store an intermediate sub-result.

16. The method of claim 13, wherein the N² master computing units are used to execute respective related matrix multiplication tasks in parallel, and the M² computing sub-units are used to execute respective related matrix multiplication sub-tasks in parallel.

17. The method The method of claim 12, wherein the first matrix and the second matrix are divided according to Cannon's algorithm rules to obtain the N² first matrix blocks and the N² second matrix blocks.

18. The method of claim 13, wherein the first matrix block and the second matrix block are divided according to Cannon's algorithm rules to obtain the M² first matrix sub-blocks and the M² second matrix sub-blocks.

19. A computer program product, comprising a program instruction used for executing matrix multiplication, wherein when the program instruction is executed by one or more processors, the method of claim 12 is implemented.
